(19) United States
(12) Patent Application Publication
(10) Pub. No.: US 2009/0021886 A1
(43) Pub. Date: Jan. 22, 2009

(54) MULTILAYER STRIP LINE CAPACITIVE ELEMENT

(75) Inventor: Koichiro Masuda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/162,085

(22) PCT Filed: Dec. 19, 2006
(86) PCT No.: PCT/JP2006/325222

§ 371 Date: Jul. 24, 2008

(30) Foreign Application Priority Data
Jan. 25, 2006 (JP) 2006-015864

(51) Int. Cl. H01G 4/30

(52) U.S. Cl. 361/301.4

(57) ABSTRACT

The capacitive element of the present invention includes a plurality of cylindrical metal pieces having different sizes, which are disposed in multiple layers surrounding a strip-shaped metal piece. A dielectric film and a conductive material layer are located between the metal piece innermostly located among the plurality of cylindrical metal pieces, and the strip-shaped metal piece, and between adjoining cylindrical metal pieces. Further, the dielectric film and the conductive material layer are laminated and disposed at positions symmetric with respect to the side wall of respective cylindrical metal piece.

### TECHNICAL FIELD

The present invention relates to a multilayer strip line capacitive element primarily used as a power supply decoupling element for the purpose of suppressing the leakage of electromagnetic waves via a power delivery circuit provided on a print circuit board etc.

### BACKGROUND ART

In recent years, the circuit operation speed of digital information devices such as personal computers and portable information terminals such as portable telephones has significantly increased with their ever-improving performance and functionality. When the clock speed is increased to a level exceeding 100 MHz, it becomes difficult to sufficiently suppress the noise (high-frequency oscillation) leaking out from a LSI to the power supply wiring of a print circuit board only by means of a previously known laminated ceramic capacitor or three-terminal capacitor. Thus, due to an increase of noise, malfunction and radio disturbances are more likely to occur. As a capacitive element which can cope with such problems, the present inventors have already proposed a strip line type element (see, for example, Japanese Patent Laid-Open Nos. 2003-101311, 2003-124066, and 2005-033813).

FIG. 1 is a sectional view of a strip line capacitive element disclosed in Patent Document 1, and FIG. 2 is a sectional view taken along line A-A in FIG. 1. As shown in those figures, dielectric film 120 made up of oxide is formed on the surface of metal plate 110. Metal plate 110 is made up of aluminum, the surface area of which is increased by 200 times through surface roughening by etching, Conductive polymer layer 131, conductive carbon paste layer 132, and silver paste layer 133 are formed on dielectric film 120, Conductive polymer layer 131, conductive carbon paste layer 132, and silver paste layer 133 form electric conductor layer 130. Anode lead terminals 111 and 112 are connected to both the longitudinal ends of metal plate 110. Metal plate 140 made up of cupper foil is placed on one surface of electric conductor layer 130, and both the longitudinal ends of metal plate 140 provide cathode lead terminals 141 and 142.

The strip line capacitive element disclosed in the above described Patent Documents is designed to enhance its capacity by increasing the surface area of the aluminum plate. However, due to a dielectric film having a single layer, it has a problem such as the shortage of the capacity per unit area, leading to a disadvantage in which it cannot be applied to a wide range of uses. Further, this related art element has polarity because its service voltage is directional, and has a structure in which a positive side electrode is surrounded by a negative side electrode. Therefore, a problem exists in that its uses are limited. That is, when connecting lead terminals 111, 112 to the power supply side, and lead terminals 141, 142 to the ground, the use of this element is limited to a circuit which has a power supply having a positive potential. Although non-polarity electrolytic capacitors are previously known (see, for example, Japanese Patent Laid-Open No. 2000-359169), a conventional non-polarity electrolytic capacitor has a problem in that the performance characteristics at high frequencies degrade because of their two-terminal structure.

### DISCLOSURE OF THE INVENTION

The present invention aims to solve the above described problems of the related arts. Its object is firstly to achieve a capacity per unit area higher than those of conventional strip line type elements, and secondly, to provide a non-polarity electrolytic capacitor having excellent high frequency characteristics.

A capacitive element of the present invention comprises a strip-shaped metal piece, a plurality of cylindrical metal pieces, and a dielectric film and a conductive material layer. The plurality of cylindrical metal pieces respectively has a different size and is disposed in multiple layers surrounding the strip-shaped metal piece. The dielectric film and conductive material layer are disposed between the metal piece innermostly located among the plurality of cylindrical metal pieces and the strip-shaped metal piece, and between the adjoining aforementioned cylindrical metal pieces. Furthermore, the dielectric film and the conductive material layer are laminated and disposed at positions that are symmetric with respect to the side wall of each cylindrical metal piece.

According to the present invention, since the dielectric film and the conductive material layer are disposed at positions symmetric with respect to the side-wall of respective cylindrical metal pieces, when the dielectric film has a polarity, a capacitor having an opposite polarity will be inevitably formed in between the strip-shaped metal piece and the cylindrical metal piece of the outermost layer. That is, the dielectric film is configured such that a capacitor to which a reverse voltage is applied is connected in series with a capacitor to which a forward voltage is applied. Therefore, it can be used as a non-polarity capacitive element. Further, the configuration in which the dielectric film and the conductive material layer are symmetrically disposed with reference to the side wall of the cylindrical metal piece makes it possible to simultaneously form the same layer on the inner and outer surfaces of the cylinder of the cylindrical metal piece, thereby simplifying the production process. Further, according to the present invention, the laminated film of the dielectric film and the conductive material layer will be formed between the strip-shaped metal piece and the cylindrical metal piece in the innermost layer, and between adjoining cylindrical metal pieces, that is, capacitors will be formed in multiple layers. Therefore, it is possible to realize a capacitor having a large capacity per unit area by connecting capacitors in parallel.

### BRIEF DESCRIPTION OF THE DRAWINGS

FIG. 1 is a sectional view in the axial direction of a related art example;

FIG. 2 is a sectional view perpendicular to FIG. 1;

FIG. 3 is a partially sectional perspective view to show a first embodiment of the multilayer strip line capacitive element of the present invention;

FIG. 4 is a partially sectional perspective view to show a second. embodiment of the multilayer strip line capacitive element of the present invention;

FIG. 5 is a partially sectional perspective view to show a third embodiment of the multilayer strip line capacitive element of the present invention;

FIG. 6 is an equivalent circuit diagram of the first and second embodiments of the present invention;

FIG. 7 is an equivalent circuit diagram of the first embodiment of the present invention;

FIG. 8 is an equivalent circuit diagram of the second embodiment of the present invention;

FIG. 9 is a sectional view (in the direction perpendicular to an internal metal piece) of Example 1 of the present invention;

FIG. 10 is a sectional view (in the direction along the internal metal piece) perpendicular to FIG. 9;

FIG. 11 is a sectional view (in the direction perpendicular to the internal metal piece) of Example 2 of the present invention;

FIG. 12 is a sectional view (in the direction along the internal metal piece) perpendicular to FIG. 11;

FIG. 13 is a sectional view (in the direction perpendicular to the internal metal piece) of Example 3 of the present invention;

FIG. 14 is a sectional view (in the direction along the internal metal piece) perpendicular to FIG. 13;

FIG. 15 is an equivalent circuit diagram to show an example when Example 3 of the present invention is used;

FIG. 16 is a sectional view (in the direction perpendicular to the internal metal piece) of Example 4 of the present invention;

FIG. 17 is a sectional view (in the direction perpendicular to the internal metal piece) of Example 5 the present invention;

FIG. 18 is an equivalent circuit diagram to show an example when Example 5 of the present invention is used;

FIG. 19 is a top view of Example 6 of the present invention;

FIG. 20 is a front view of Example 6 of the present invention;

FIG. 21 is a side view of Example 6 of the present invention;

FIG. 22 is a top view of Example 7 of the present invention;

FIG. 23 is a front view of Example 7 of the present invention;

FIG. 24 is a side view of Example 7 of the present invention;

FIG. 25 is an equivalent circuit diagram to show an example when Example 7 of the present invention is used;

FIG. 26 is a top view of Example 8 of the present invention;

FIG. 27 is a front view of Example 8 of the present invention;

FIG. 28 is a side view of Example 8 of the present invention; and

FIG. 29 is an equivalent circuit diagram to show an example when Example 8 of the present invention is used.

### BEST MODE FOR CARRYING OUT THE INVENTION

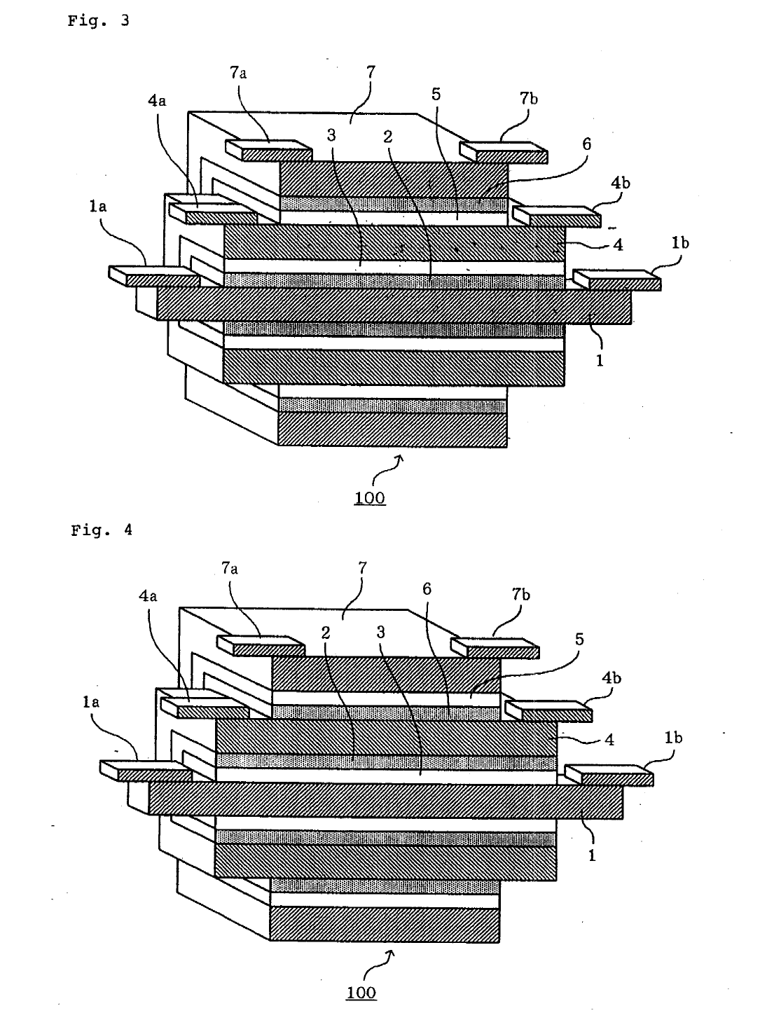

Next, embodiments of the present invention will be described in detail with reference to the drawings. FIGS. 3, 4, and 5 are partially sectional perspective views to respectively show a first, second, and third embodiments of the present invention.

As shown in FIG. 3, multilayer strip line capacitive element 100 comprises: cylindrical first cylinder metal piece 4; internal metal piece 1 disposed within first cylinder metal piece 4; second cylinder metal piece 7 disposed outside first cylinder metal piece 4; dielectric film 3 and conductive material layer 2 provided in the gap between first cylinder metal piece 4 and internal metal piece 1; dielectric film 5 and conductive material layer 6 provided in the gap between first cylinder metal piece 4 and second cylinder metal piece 7; lead terminals 1a and 1b provided at both ends of internal metal piece 1; lead terminals 4a and 4b provided at both ends of first cylinder metal piece 4; and lead terminal 7a and 7b provided at both ends of second cylinder metal piece 7. In this configuration, the positional relationship between dielectric films 3, 5 and conductive material layers 2, 6 with respect to first cylinder metal piece 4 is symmetric with reference to the side wall of first cylinder metal piece 4. That is, inwardly from first cylinder metal piece 4, dielectric film 3 and conductive material layer 2 are disposed in that order, and outwardly from first cylinder metal piece 4, dielectric film 5 and conductive material layer 6 are disposed in that order.

Internal metal piece 1 is a strip-shaped metal piece, and may either have an elongated plate shape or a bar (round bar or square bar) shape, Further, first and second cylinder metal pieces 4 and 7 may have a cylindrical shape, an elliptic cylindrical shape, or a square cylindrical shape. Preferably, internal metal piece 1 and second cylinder metal piece 7 are formed of a high electric conductivity material such as aluminum, cupper, silver, gold, and the like. It is because it makes the parasitic impedance of the electrode as low as possible. As for first cylinder metal piece 4, when a metal which exhibits a valve action (hereinafter referred to as a valve action metal) is used, that requirement will take precedence. Otherwise, however, the same selection criterion is applied for the selection of the material of internal metal piece 1 and second cylinder metal piece 7.

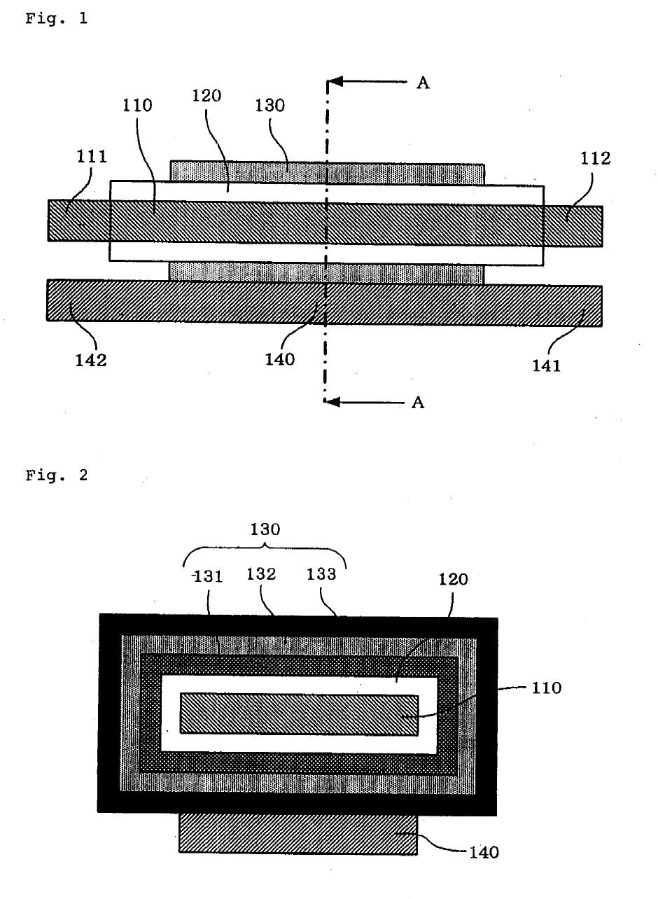

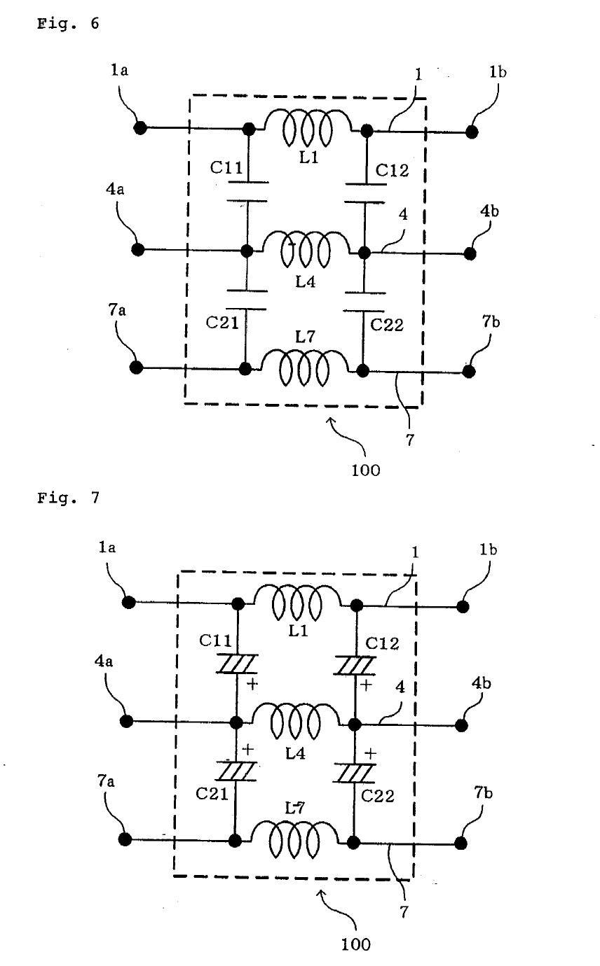

FIG. 6 is an equivalent circuit diagram of multilayer strip line capacitive element 100 of a first embodiment. As shown in FIG. 6, inductances L1, L4 and L7 are formed respectively in internal metal piece 1, first cylinder metal piece 4, and second cylinder metal piece 7. Moreover, capacitors C11 and C12 are formed between internal metal piece 1 and first cylinder metal piece 4, and capacitors C21 and C22 are formed between first cylinder metal piece 4 and second cylinder metal piece 7. The related art example shown in FIGS. 1 and 2 only comprises; capacitors C11 and C12, but according to the present invention, capacitors C21 and C22 are added. Therefore, connecting capacitors C11, C12 with capacitors C21, C22 in parallel will create a large capacity around first cylinder metal piece 4. Further, in an aspect in which capacitors C11, C12 and capacitors C21, C22 are connected in parallel, inductances L1 and L7 are also connected in parallel. Thus, inductance will also be reduced, thereby enabling the reduction of characteristic impedance.

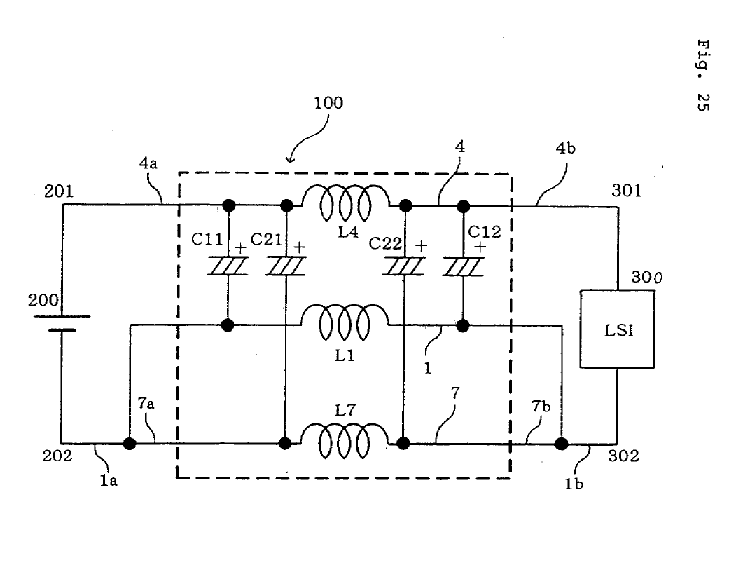

Now, supposing that lead terminals 1a, 4a, 7a are input terminals, and lead terminals 1b, 4b, 7b are output terminals, they will form a filter that is made up of capacitors C11, C12 and inductances L1, L4, and a filter that is made up of capacitors C21, C22 and inductances L4, L7. Combining the connection of those lead terminals makes it possible to make up various filters by using a single element. For example, if first cylinder metal piece 4 is connected to a positive electrode, and internal metal piece 1 and second cylinder metal piece 7 are commonly grounded, capacitors C11, C12 and capacitors C21, C22 will be added as shown in FIG. 25 and static capacitance will be increased by around two times, thereby improving the filter function.

Dielectric films 3, 5 may be a metal oxide film. When dielectric films 3, 5 are a metal oxide film, first cylinder metal piece 4 may be a valve action metal and the dielectric film may be an anodic oxide film. The valve action metal includes, but is not limited to, aluminum, tantalum, niobium, and titanium. The surface of first cylinder metal piece 4 is etched so that the surface area thereof is increased by 200 times. When dielectric films 3, 5 are an insulator film formed through anodic oxidation of first cylinder metal piece 4, which is a valve action metal, and when in addition at least a portion of conductive material layer 2, 6 in contact with the dielectric film is made up of a solid electrolyte material, an equivalent circuit diagram will be shown as FIG. 7. That is, capacitors C11, C12, C21 and C22, which are formed between internal metal piece 1 and first cylinder metal piece 4 and between first cylinder metal piece 4 and second cylinder metal piece 7 will be electrolytic capacitors whose positive electrode is on the side of first cylinder metal piece 4.

When no electrolytic capacitor is formed between metal pieces, dielectric films 3 and 5 may also be formed having a high permittivity dielectric. Alternatively, they may also be formed of an organic dielectric.

When an electrolytic capacitor is formed between metal pieces, at least a portion of conductive material layer 2, 6 in contact with dielectric film 3, 5 is formed of a conductive polymer. A preferable material includes polypyrroles, polythiophenes and polyanilines, and may also include derivatives thereof. The preferable material may not be a single material but may be a mixture of multiple materials.

In order to retain a low contact resistance with internal metal piece 1 or second cylinder metal piece 7, conductive material layers 2, 6 preferably form a conductive layer made up of a higher conductivity material between the conductive polymer and those metal pieces. In the present invention, a laminate film made of a carbon graphite layer and a silver paste layer is advantageously used.

Lead terminals 1a and 1b provided at both ends of internal metal piece 1, lead terminals 4a and 4b provided at both ends of first cylinder metal piece 4, and lead terminals 7a and 7b provided at both ends of second cylinder metal piece 7 are made of metal. Therefore, they are fixed to metal pieces 1, 4, 7 by means of laser welding, resistance welding, ultrasonic welding, brazing, caulking, and the like. Alternatively, conductive adhesives and metal deposition by plating may be used as the method of connecting a lead terminal is and metal pieces 1, 4, 7. As for internal metal piece 1, an extension of internal metal piece 1 may be used as a terminal without providing a separate metal terminal thereon. The lead terminal is used as processed into an appropriate shape that adapted for the form of connection. Further, it is subjected to surface treatment for soldering as required.

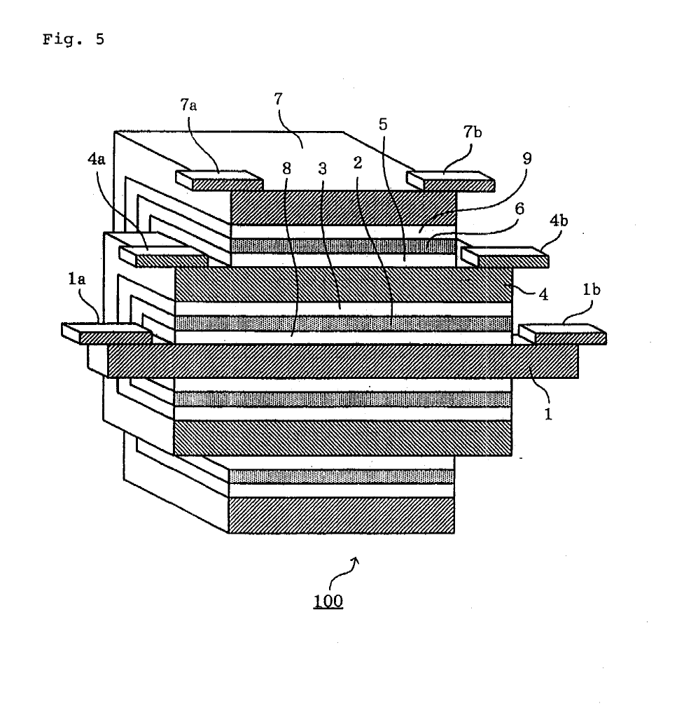

In FIG. 4, since parts like as those of FIG. 3 are designated by the same reference numerals, overlapped description will be omitted (the same as in FIG. 5). A second embodiment shown in FIG. 4 is configured such that the positions for forming conductive material layers 2 and 6 and dielectric films 3 and 5 are interchanged, compared with the first embodiment. That is, in the second embodiment of FIG. 4, conductive material layer 2 and dielectric film 3 are disposed in this order from first cylinder metal piece 4 toward internal metal piece 1, and conductive material layer 6 and dielectric film 5 are disposed in this order from first cylinder metal piece 4 toward second cylinder metal piece 7. In any case, the disposing positions of the conductive material layer and the dielectric film are symmetric with reference to the side wall of first cylinder metal piece 4.

When a capacitor to be formed between metal pieces is not an electrolytic capacitor, or even if it is an electrolytic capacitor, when its polarity is not set, an equivalent circuit diagram of the second embodiment will become such a form as shown in FIG. 6. When an electrolytic capacitor is formed between metal pieces, internal metal piece 1 and second cylinder metal piece 7 are formed of a valve action metal. The surfaces of internal metal piece 1 and second cylinder metal piece 7 are etched so that the surface areas thereof are increased, for example, by about 200 times. Further, on the surfaces thereof, there are formed dielectric films 3 and 5, which have been formed through anodic oxidation.

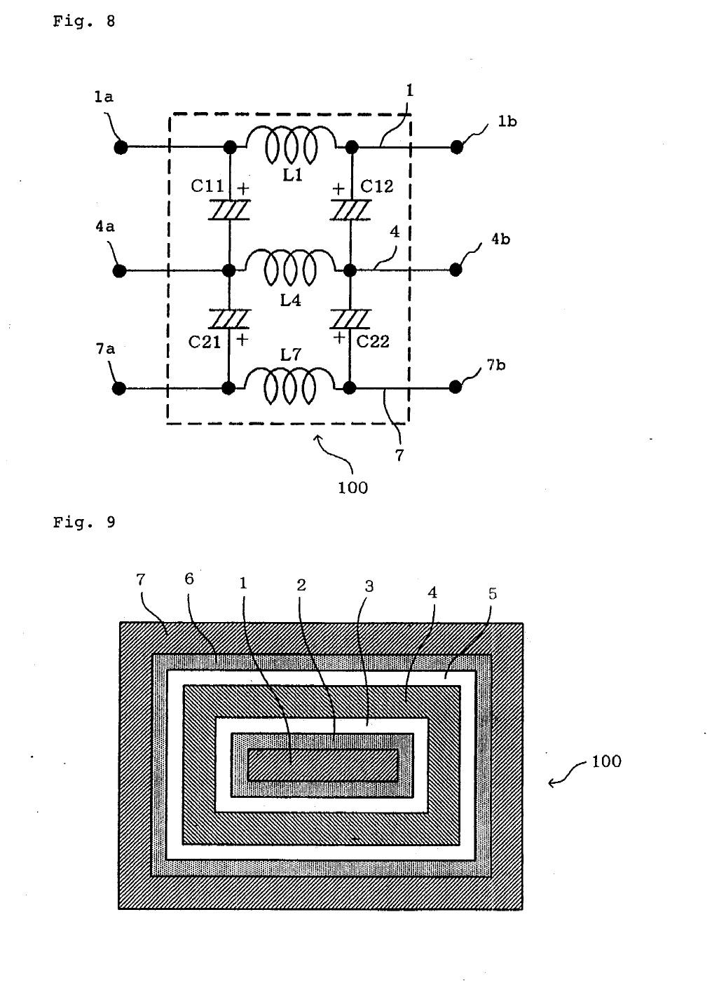

FIG. 8 shows an equivalent circuit diagram when electrolytic capacitors are formed between metal pieces of the second embodiment. The polarity of the electrolytic capacitor is reversed compared with the case of the first embodiment shown in FIG. 7.

When lead terminals 1a, 1b, 7a, 7b are grounded, lead terminal 4a is used as an input terminal (power supply side terminal), and lead terminal 4b is used as an output terminal (load side terminal), the multilayer strip line capacitive element which makes up the equivalent circuit of FIG. 7 is suitable for application to a circuit having a positive potential power supply. On the other hand, the multilayer strip line capacitive element in the equivalent circuit of FIG. 8 is suitable for application to a circuit having a negative potential power supply.

The multilayer strip line capacitive elements of the first and second embodiments shown in FIGS. 7 and 8 are configured such that both lead terminals of first cylinder metal piece 4 are opened and only the lead terminals of internal metal piece 1 and second cylinder metal piece 7 are utilized. According to this configuration, either capacitor C11 (C12) or capacitor C21 (C22) will be applied with a forward voltage so that it can be used as a non-polarity capacitive element.

A third embodiment shown in FIG. 5 is configured with respect to the first embodiment such that dielectric film 8 is inserted between internal metal piece 1 and conductive material layer 2, and dielectric film 9 is inserted between second cylinder metal piece 7 and conductive material layer 6. That is, in the third embodiment, dielectric film 3, conductive material layer 2, and dielectric film 8 are disposed in that order from first cylinder metal piece 4 toward internal metal piece 1; and dielectric film 5, conductive material layer 6, and dielectric film 9 are disposed in that order from first cylinder metal piece 4 toward second cylinder metal piece 7. In this case as well, the disposing positions of the dielectric film and the conductive material layer are symmetric with reference to the side wall of first cylinder metal piece 4.

When an electrolytic capacitor is formed between metal pieces, internal metal piece 1, first cylinder metal piece 4, and second cylinder metal piece 7 are formed by use of a valve action metal. The surfaces of internal metal piece 1, first cylinder metal piece 4, and second cylinder metal piece 7 are etched to increase the surface areas thereof. Moreover, respective surface is formed with dielectric films 8, 3, 5 and 9 which are formed through anodic oxidation.

### EXAMPLE 1

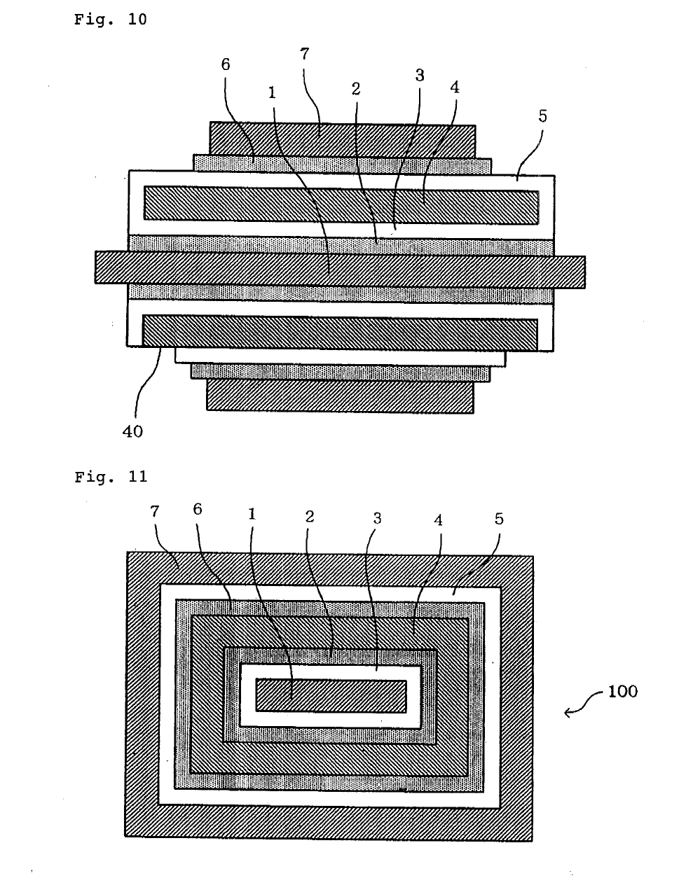

FIG. 9 is a sectional view perpendicular to the longitudinal direction of internal metal piece 1 of the first embodiment, and FIG. 10 is a sectional view perpendicular to that of FIG. 9. As shown in FIG. 9, internal metal piece 1 is provided within cylindrical first cylinder metal piece 4, and cylindrical second cylinder metal piece 7 is provided outside first cylinder metal piece 4. Dielectric film 3 and conductive material layer 2 are disposed in the gap between first cylinder metal piece 4 and internal metal piece 1, dielectric film 5 and conductive material layer 6 are disposed in the gap between first cylinder metal piece 4 and second cylinder metal piece 7. In the present example, first cylinder metal piece 4 is formed of aluminum that has a valve action, and dielectric films 3 and 5 are formed of aluminum oxide. Further, conductive material layers 2, 6 are formed of a laminate which is formed by laminating conductive polymer (polythiophene), carbon graphite, and silver paste in that order from dielectric film 3, 5 side.

Next, the production process of the present example will be described.

Two sheets of aluminum foil, which had a length of 20 mm, a width of 13 mm, and a thickness of 110 μm and whose surface was roughened by etching treatment to increase the surface area thereof by about 200 times, were prepared. The two sheets were placed with one on top of another, and welded together along two straight lines spaced at 10 mm. Then, outside portions having a 10 mm weld spacing were cut off to obtain a generally cylindrical valve action metal with both sides being connected.

The above described valve action metal was subjected to anodic oxidation at a voltage of 10 V in an aqueous solution of ammonium borate with the cylindrical internal space being slightly expanded such that the two sheets of aluminum foil connected at both sides would not come into contact with each other, and thereafter was washed and dried. Thereby, dielectric films 3, 5 made up of metal oxide coating (aluminum oxide) were formed on the inner and outer surfaces of a valve action metal.

Next, resin made up of hexafluoropropylene, which is mask resin, was applied on both ends of the valve action metal to form an insulating bank. Thus, a valve action metal (first cylinder metal piece 4) after mask process was obtained.

Further, an ethanol solution containing 10% by mass concentration of iron(II) dodecylbenzenesulfonate was prepared. The valve action metal after mask process was soaked into the solution and taken out, and thereafter was dried at room temperature for 30 minutes in the air. Then, the valve action metal was soaked into an aqueous solution containing 50% by mass of ethylene-dioxy thiophene and taken out to be kept in the air for 30 minutes, thereby carrying out polymerization of the aforementioned ethylene-dioxy thiophene. Thereafter, the valve action metal was washed with water and methanol and dried at 80 degrees C. The above described operation was repeated four times so that dielectric film 3 at the inside of first cylinder metal piece 4 and dielectric film 5 at the outside of first cylinder metal piece 4 were respectively coated with conductive polymer. The conductive polymer was made up of polyethylene-dioxy thiophene for which dodecylbenzenesulfonic acid was used as a dopant. Thus, first cylinder metal piece 4 including a conductive polymer layer free from defects was obtained. This first cylinder metal piece 4 was soaked into a solvent solution containing carbon graphite and taken out to be dried at room temperature. Further, upon hardening of the surface of carbon graphite, first cylinder metal piece 4 was soaked in silver paste and taken out to be dried at 60 degrees C. for 15 minutes. Thereafter, it was left standing at room temperature for 3 hours. So far, there was obtained first cylinder metal piece 4 in which conductive material layers 2, 6 made up of conductive polymer, carbon graphite, and silver paste were formed.

A metal plate (internal metal piece 1) applied with silver paste was inserted into the inside of the cylinder of first cylinder metal piece 4 and a thin metal foil (second cylinder metal piece 7) was pasted on the outside of first cylinder metal piece 4 with silver paste, thereafter being dried and hardened at 60 degrees C. for 30 minutes. Thereby, first cylinder metal piece 4 was obtained in which components from internal metal piece 1 to second cylinder metal piece 7 were formed. First cylinder metal piece 4 was soaked in tetrahydrofuran to dissolve hexafluoropropylene, which is mask resin, thereby removing conductive polymer, carbon graphite and silver paste that exist on the bank. Further, dielectric film 5 outside both ends of first cylinder metal piece 4 was cut off to obtain multilayer strip line capacitive element 100 of the present example in which cut part 40 was formed.

Here, if the weld part of first cylinder metal piece 4 can be insulated so that conductive materials or the like in the inside and the outside of first cylinder metal piece 4 will not be brought into electric conduction, it is possible to weld the materials so as to leaving clearance. The weld spacing may be any negligible distance compared with the wavelength of the maximum frequency to be used. For example, tanking into consideration the condition of an occurrence of a shut down mode in a waveguide, the spacing may be clearly less than one half of the wavelength, and more preferably less than one fourth of the wavelength, When a fracture in the dielectric film is permissible, there is no need to select a material which has the functions of fracture repairing and short-circuit prevention provided that it has conductivity.

It is noted that the equivalent circuit of the present example is similar to those shown in FIGS. 6 and 7.

### EXAMPLE 2

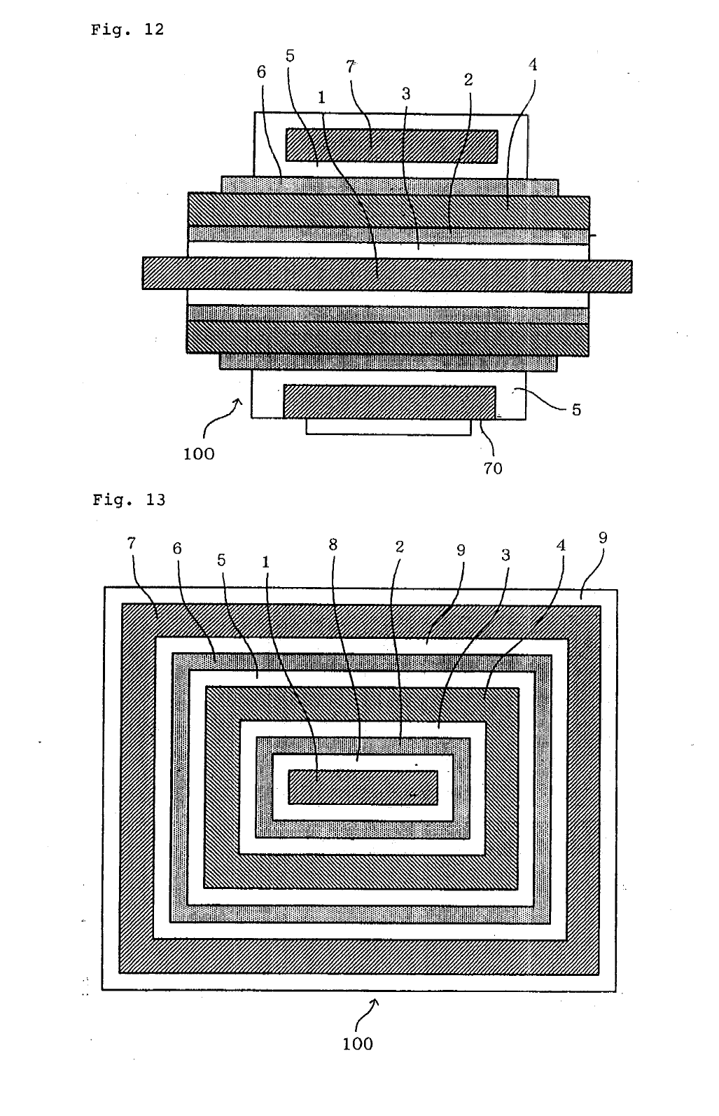

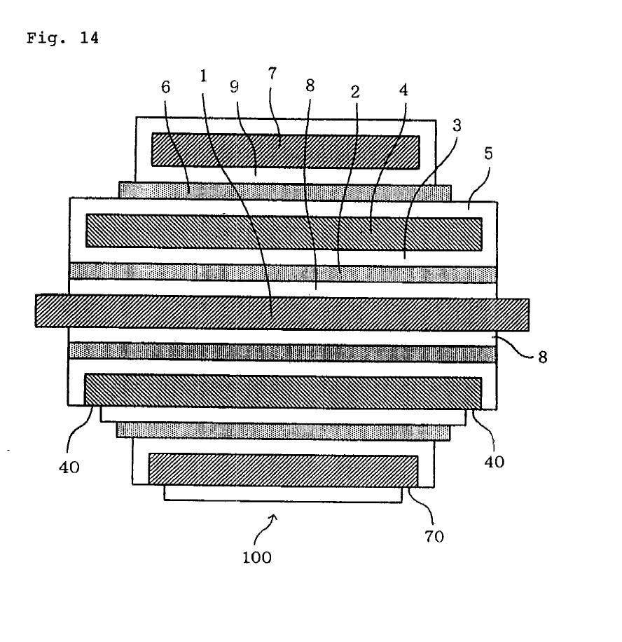

FIG. 11 is a sectional view perpendicular to the longitudinal direction of internal metal piece 1 of Example 2, and FIG. 12 is a sectional view perpendicular to that of FIG. 11. The present example is configured such that the positional relationship between dielectric films 3, 5 and conductive material layers 2, 6 is reversed with respect to Example 1. That is, conductive material layer 2 and dielectric film 3 are disposed in that order toward the inside of first cylinder metal piece 4, and conductive material layer 6 and dielectric film 5 are disposed in that order toward the outside of first cylinder metal piece 4.

In the present example, aluminum which is a valve action metal is used for internal metal piece 1 and second cylinder metal piece 7.

Next, the production process of the present example will be described.

Aluminum foil which had a thickness of 110 μm and whose surface was roughened by etching treatment to increase the surface area thereof by about 200 times, was prepared. This aluminum foil was formed into a width of 8 mm and a length of 30 mm to obtain a rectangular valve action metal (internal metal piece 1) which would provide internal metal piece 1.

Further two sheets of the above described aluminum foil having a width of 15 mm and a length of 20 mm were prepared. This two sheets were placed with one on top of another, and welded together along two straight lines spaced at 12 mm. Then, outside portions of the 12 mm weld spacing were cut off to obtain a generally cylindrical valve action metal (second cylinder metal piece 7) with both sides being connected.

The above described two types of valve action metals were subjected to anodic oxidation at a voltage of 10 V in aqueous solution of ammonium borate, and thereafter washed and dried. Thereby, dielectric films 3, 5 made up of metal oxide coating (aluminum oxide) were formed on the inner and outer surfaces of respective valve action metals. It is noted that when subjecting the cylindrical valve action metal to anodic oxidation, the cylindrical internal space thereof was slightly expanded so that two sheets of aluminum foil would not come into contact with each other.

Next, resin made up of hexafluoropropylene, which is mask resin, was applied to both ends of the rectangular valve action metal and the outside surface of the cylindrical valve action metal to form an insulating bank.

Thereby a rectangular valve action metal (internal metal piece 1) after mask process and a cylindrical valve action metal (second cylinder metal piece 7) were obtained.

Further, an ethanol solution containing 10% by mass concentration of iron(II) dodecylbenzenesulfonate was prepared. Both valve action metals after mask process were soaked into the solution and taken out, thereafter were dried at room temperature for 30 minutes in the air. Then the valve action metals were soaked in an aqueous solution containing 50% by mass of ethylene-dioxy thiophene and taken out to be kept in the air for 30 minutes, thereby carrying out polymerization of the aforementioned ethylene-dioxy thiophene. Thereafter, the valve action metals were washed with water and methanol and dried at 80 degrees C. The above described operation was repeated four times so that dielectric film 3 on the surface of internal metal piece 1, and dielectric film 5 on the inside of second cylinder metal piece 7 were respectively coated with conductive polymer. The conductive polymer was made up of polyethylene-dioxy thiophene for which dodecylbenzenesulfonic acid was used as a dopant. Thus, internal metal piece 1 and second cylinder metal piece 7 including a conductive polymer layer free from defects were obtained. Internal metal piece 1 and second cylinder metal piece 7 were soaked into a solvent solution containing carbon graphite and taken out to be dried at room temperature. Further, upon hardening of the surface of carbon graphite, internal metal piece 1 and second cylinder metal piece 7 were soaked in silver paste and taken out to be dried at 60 degrees C. for 15 minutes. Thereafter, they were left standing at room temperature for 3 hours. So far, there were obtained: an internal metal piece in which conductive material layer 2 made up of conductive polymer, carbon graphite, and silver paste was formed, and second cylinder metal piece 7 in which conductive material layer 6 made up of the same three materials was formed.

Internal metal piece 1 was applied on the surface with silver paste and was inserted into the inside of first cylinder metal piece 4. Then, first cylinder metal piece 4 was applied on the outside with silver paste and was inserted into the inside of the cylinder of second cylinder metal piece 7, Thereafter, the assembly was dried and hardened at 60 degrees C. for 30 minutes. Thereby, components from internal metal piece 1 to second cylinder metal piece 7 were formed. Those were soaked into tetrahydrofuran to dissolve hexafluoropropylene, which is mask resin, thereby removing conductive polymer, carbon graphite, and silver paste on the mask resin, at the same time.

Further, dielectric film 3 at both ends of internal metal piece 1 and dielectric film 5 outside both ends of second cylinder metal piece 7 were cut off to obtain multilayer strip line capacitive element 100 of the present example in which cut part 70 was formed.

It is noted that the equivalent circuit of the present example is similar to those shown in FIGS. 6 to 8.

### EXAMPLE 3

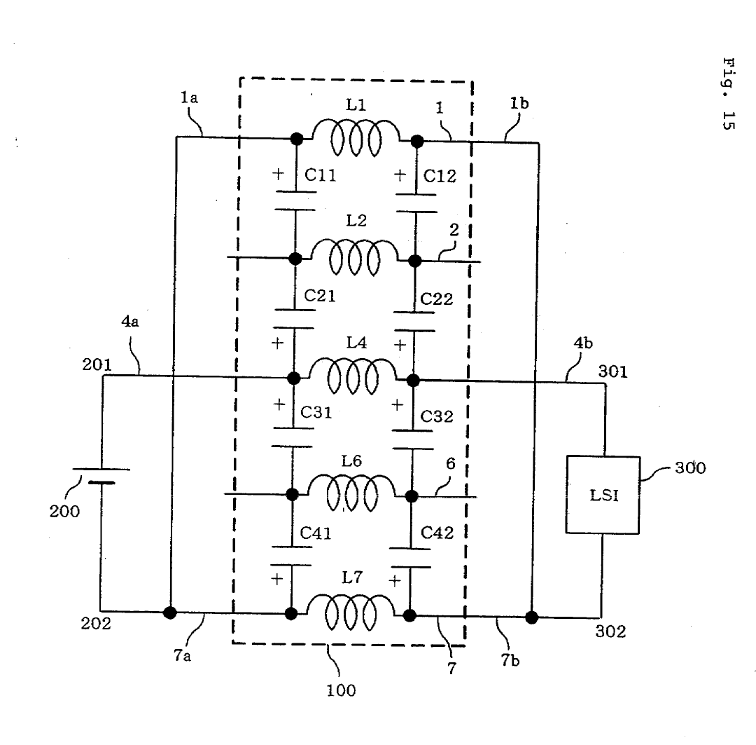

FIG. 13 is a sectional view perpendicular to the longitudinal direction of internal metal piece 1 of Example 3, and FIG. 14 is a sectional view perpendicular to that of FIG. 13. As shown in FIGS. 13 and 14, dielectric film 3, conductive material layer 2, and dielectric film 8 are disposed in that order inwardly from first cylinder metal piece 4 in the gap between first cylinder metal piece 4 and internal metal piece 1. Further, dielectric film 5, conductive material layer, and dielectric film 9 are disposed in that order outwardly from first cylinder metal piece 4 in the gap between first cylinder metal piece 4 and second cylinder metal piece 7.

In the present example, aluminum which is a valve action metal was used for internal metal piece 1, first cylinder metal piece 4, and second cylinder metal piece 7.

Next, the production process of the present example will be described.

Aluminum foil, which had a thickness of 110 μm and whose surface was roughened by etching treatment to increase the surface area thereof by about 200 times, was prepared. This aluminum foil was formed into a width of 8 mm and a length of 30 mm to obtain a rectangular valve action metal (internal metal piece 1) which becomes internal metal piece 1.

Further four sheets of the above described aluminum foil having a width of 15 mm and a length of 20 mm were prepared. Two of these sheets were placed one on top of another, and welded together along two straight lines spaced at 10 mm. Then, the outside portions of the 10 mm weld spacing were cut off to obtain a generally cylindrical valve action metal (first cylinder metal piece 4) with both sides being connected. Further, two sheets of the above described aluminum foil were placed one on top of another, and welded together along two straight lines spaced at 12 mm. Then, the outside portions of the 12 mm weld spacing were cut off to obtain a generally cylindrical valve action metal (second cylinder metal piece 7) with both sides being connected.

The above described three types of valve action metals were subjected to anodic oxidation at a voltage of 10 V in an aqueous solution of ammonium borate, and thereafter were washed and dried. Thereby, dielectric films 3, 5, 8, 9 made up of metal oxide coating (aluminum oxide) were formed on the inner and outer surfaces of respective valve action metals. It is noted that when subjecting the two types of cylindrical valve action metals to anodic oxidation, the cylindrical internal space thereof was slightly expanded so that two sheets of aluminum foil would not come into contact with each other.

Next, resin made up of hexafluoropropylene, which is mask resin, was applied to both ends of one rectangular valve action metal, both ends of one cylindrical valve action metal (first cylinder metal piece 4), and the outer surface of another cylindrical valve action metal (second cylinder metal piece 7) to form an insulating bank. Thereby a rectangular valve action metal (internal metal piece 1) after mask process and two types of cylindrical valve action metals (first cylinder metal piece 4 and second cylinder metal piece 7) were obtained.

Further, an ethanol solution containing 10% by mass concentration of iron(II) dodecylbenzenesulfonate was prepared. The three types of valve action metals after mask process were soaked into the solution and taken out, and thereafter were dried at room temperature for 30 minutes in the air. Then the valve action metals were soaked in an aqueous solution containing 50% by mass of ethylene-dioxy thiophene and taken out to be kept in the air for 30 minutes, thereby carrying out polymerization of the aforementioned ethylene-dioxy thiophene, Thereafter, the valve action metals were washed with water and methanol and dried at 80 degrees C. The above described operation was repeated four times so that dielectric film 8 on the surface of internal metal piece 1, dielectric film 3 on the inside surface of first cylinder metal piece 4, dielectric film 5 on the outside surface of first cylinder metal piece 4, and dielectric film 9 on the inside of second cylinder metal piece 7 were respectively coated with conductive polymer. The conductive polymer was made up of polyethylene-dioxy thiophene for which dodecylbenzenesulfonic acid was used as a dopant. Thus, internal metal piece 1, first cylinder metal piece 4 and second cylinder metal piece 7 including a conductive polymer layer free from defects were obtained. These were soaked into a solvent solution containing carbon graphite and taken out to be dried at room temperature. Further, upon hardening of the surface of carbon graphite, internal metal piece 1, first cylinder metal piece 4 and second cylinder metal piece 7 were soaked in silver paste and taken out to be dried at 60 degrees C. for 15 minutes. Thereafter, these were left standing at room temperature for 3 hours. So far, there were obtained: internal metal piece 1 in which conductive material layer 2 made up of conductive polymer, carbon graphite, and silver paste was formed; first cylinder metal piece 4 in which conductive material layers 2, 6 made up of the same three materials were formed; and second cylinder metal piece 7 in which conductive material layer 6 made up of the same three materials was formed.

Internal metal piece 1 was coated on the surface with silver paste and was inserted into the inside of first cylinder metal piece 4. Then first cylinder metal piece 4 was coated on the outside with silver paste and was inserted into the inside of the cylinder of second cylinder metal piece 7. Thereafter, the assembly was dried and hardened at 60 degrees C. for 30 minutes. Thereby, components from internal metal piece 1 to second cylinder metal piece 7 were formed. Those were soaked in tetrahydrofuran to dissolve hexafluoropropylene, which is mask resin, thereby removing conductive polymer, carbon graphite, and silver paste on the mask resin, at the same time. Further, dielectric film 8 at both ends of internal metal piece 1, dielectric film 5 outside both ends of first cylinder metal piece 4, and dielectric film 9 outside both ends of second cylinder metal piece 7 were cut off to obtain multilayer strip line capacitive element 100 of the present example in which cut parts 40 and 70 were formed.

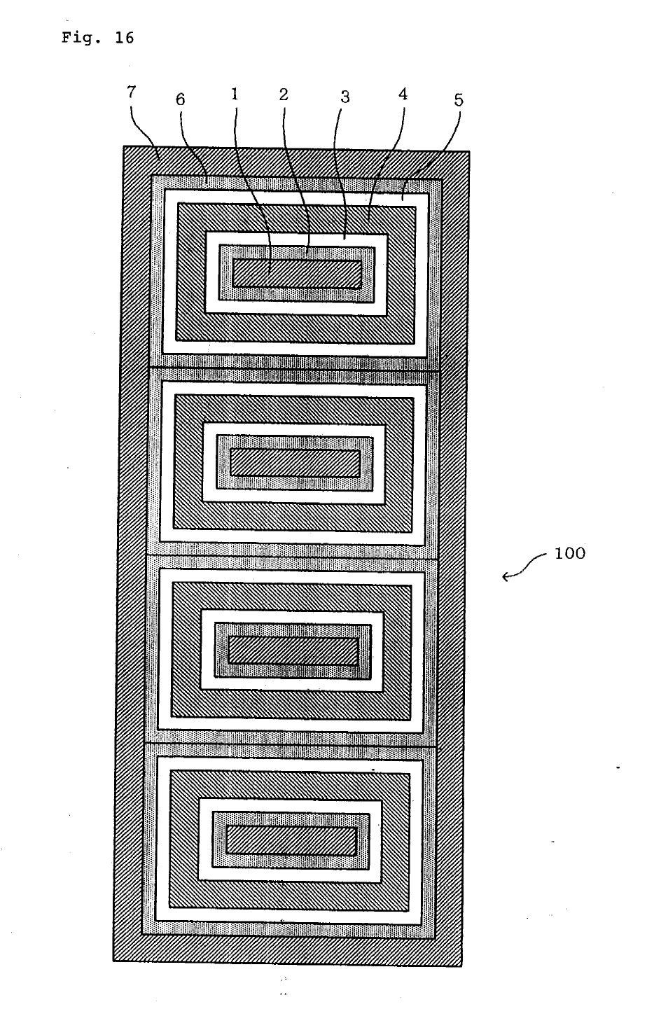

FIG. 15 is a schematic circuit diagram to show an example when the present example is used. As shown in the figure, inductances L1, L2, L4, L6, L7 are parasitic on internal metal piece 1, conductive material layer 2, first cylinder metal piece 4, conductive material layer 6, and second cylinder metal piece 7. Further, capacitors C11, C12 are formed between internal metal piece 1 and conductive material layer 2. Capacitors C21, C22 are formed between conductive material layer 6 and first cylinder metal piece 4. Capacitors C31, C32 are formed between first cylinder metal piece 4 and conductive material layer 6. Capacitors C41, C42 are formed between conductive material layer 6 and second cylinder metal piece 7. Both ends of each of internal metal piece 1, first cylinder metal piece 4, and second cylinder metal piece 7 form lead terminals 1a, 1b; 4a, 4b; 7a, 7b. Lead terminal 4a is connected to positive electrode 201 of power supply 200, and lead terminal 4b to electrode terminal 301 of LSI 300. Further, lead terminals 1a, 7a are commonly connected to negative electrode 202 of power supply 200, and lead terminals 1b, 7b are commonly connected to ground terminal 302 of LSI 300.

In such a connection, electrode terminal 301 of LSI 300 are separated from positive electrode 201 of power supply 200 by inductance L4. Further, noise propagated from electrode terminal 301 of LSI 300 to positive electrode 201 of power supply 200 is attenuated by a filter formed between first cylinder metal piece 4 and internal metal piece 1, and a filter formed between first cylinder metal piece 4 and second cylinder metal piece 7.

Capacitors C11 and C21 and capacitors C12 and C22, which are formed between internal metal piece 1 and first cylinder metal piece 4, respectively have an opposite polarity. Similarly, capacitors C31 and C41 and capacitors C32 and C42, which are formed between first cylinder metal piece 4 and second cylinder metal piece 7, have respectively an opposite polarity. Therefore, the multilayer strip line capacitive element 100 of the present example has no polarity in itself. That is, it can be used in the circuit shown in FIG. 15, and even if LSI 300 is an integrated circuit powered by a negative voltage, the multilayer strip line capacitive element 100 can be used in the same circuit configuration only by reversing the polarity of power supply 200. In the circuit connection shown in FIG. 15, a forward voltage is applied to capacitors C21, C22, C31, C32, while a reverse voltage is applied to capacitors C11, C12, C41, C42. Capacitors C11, C12, C41, C42, which are applied with a reverse voltage, will be sort-circuited and will not function properly. Therefore, only capacitors C21, C22, C31, C32 will function as a filter.

### EXAMPLE 4

FIG. 16 is a sectional view perpendicular to the longitudinal direction of internal metal piece 1 of Example 4. The present example is configured, as shown in FIG. 16, such that a plurality of sets (four sets in the present example) of the combination of internal metal piece 1 and first cylinder metal piece 4 are disposed in an array within second cylinder metal piece 7.

The production process of the present example will be briefly described. Dielectric films 3, 5 were formed on the inner and outer surfaces of a cylindrical valve action metal, which would provide first cylinder metal piece 4, by using the same method as that of Example 1. Mask resin was applied on both ends of the valve action metal to form an insulating bank. The valve action metal (first cylinder metal piece 4) after mask process was coated with conductive polymer, and thereafter was further applied with carbon graphite and silver paste. A metal plate (internal metal piece 1) applied with silver paste was inserted into the inside of first cylinder metal piece 4.

Four of first cylinder metal pieces 4 which were obtained as described above and in which internal metal piece 1 was disposed, were placed in a line, and thin metal foil (second cylinder metal piece 7) was pasted on the outside of four first cylinder metal pieces 4 by using silver paste. Next, mask resin was removed together with conductive polymer, carbon graphite, and silver paste thereon. Further, multilayer strip line capacitive element 100 of the present example was obtained in which a cut part (not shown) was formed by cutting off dielectric film 5 that was outside both ends of first cylinder metal piece 4.

According to the present example, it becomes possible to separate the input side (power supply side) and the output side (load side) of multiple power supply wiring, which are disposed in a small area, by a single element thereby contributing to achieving compact implementation.

Although a valve action metal was used for first cylinder metal piece 4 in the present example, a valve action metal may be used for both internal metal piece 1 and second cylinder metal piece 7. Alternatively, a valve action metal may be used for all the metal pieces.

### EXAMPLE 5

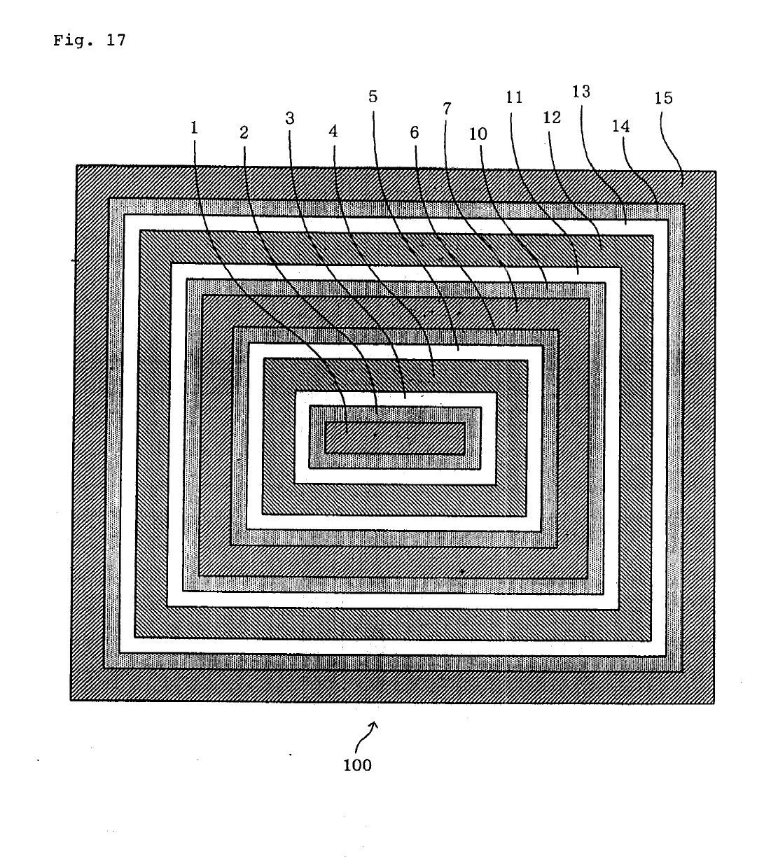

FIG. 17 is a sectional view perpendicular to the longitudinal direction of internal metal piece 1 of Example 5. Although there were two cylindrical metal pieces in Examples 1 to 4, there are two more cylindrical metal pieces disposed outside the second cylinder metal piece in the present example. That is, as shown in FIG. 17, internal metal piece 1, first cylinder metal piece 4, second cylinder metal piece 7, third cylinder metal piece 12, and fourth cylinder metal piece 15 are provided in this order from the inside and with a spacing therebetween. Conductive material layer 2 and dielectric film 3 are formed between internal metal piece 1 and first cylinder metal piece 4. Dielectric film 5 and conductive material layer 6 are formed between first cylinder metal piece 4 and second cylinder metal piece 7. Conductive material layer 10 and dielectric film 11 are formed between second cylinder metal piece 7 and third cylinder metal piece 12. Dielectric film 13 and conductive material layer 14 are formed between third cylinder metal piece 12 and fourth cylinder metal piece 15. In the present example as well, the disposing positions of a conductive material layer and a dielectric film between adjoining metal pieces are symmetric with reference to the side wall of any cylinder metal piece of first, second, and third cylinder metal pieces. In the present example, a valve action metal is used for first and third cylinder metal pieces 4, 12.

Next, the production method of the present example will be described.

Two sheets of Aluminum foil having a thickness of 110 μm and whose surface was roughened by etching treatment to increase the surface area thereof by about 200 times, were prepared. These sheets of aluminum foil were formed into a width of 13 mm and a length of 30 mm, and placed one on top of another to be welded along two straight lines spaced at 10 mm from each other. Then, the outside portions of the 10 mm weld spacing were cutoff to obtain a generally cylindrical valve action metal (first cylinder metal piece 4) both sides of which were connected. Further, two sheets with a width of 16 mm and a length of 20 mm of the above described aluminum foil were placed one on top of another to be welded along two straight lines spaced at 14 mm from each other. Outside portions of the 14 mm weld spacing were cut off to obtain a generally cylindrical valve action metal (third cylinder metal piece 12) both sides of which were connected.

In addition to those, a rectangular metal piece (internal metal piece 1) having a length of 35 mm and a width of 8 mm was obtained from aluminum foil having a flat surface and a width of 80 μm. Further, the same aluminum foil was formed into a width of 15 mm and a length of 25 mm and placed one on top of another to be welded along two straight lines spaced at 12 mm from each other. Then, outside portions of the 12 mm weld spacing were cut off to obtain a generally cylindrical valve action metal (second cylinder metal piece 7) both sides of which were connected.

Next, the two types of cylindrical valve action metals (first cylinder metal piece 4 and third cylinder metal piece 12) were subjected to anodic oxidation at a voltage of 10V in an aqueous solution of ammonium borate, and thereafter were washed and dried. Thereby, dielectric films 3, 5, 11, and 13 made up of metal oxide coating (aluminum oxide) were formed on the inner and outer surfaces of respective valve action metals. It is noted that when subjecting the cylindrical valve action metals to anodic oxidation, the cylindrical internal space thereof was slightly expanded so that two sheets of aluminum foil, whose surfaces were roughed, would not come into contact with each other.

Next, resin made up of hexafluoropropylene which is mask resin was applied to both ends of the cylindrical valve action metals to form an insulating bank. Thereby cylindrical valve action metals (first cylinder metal piece 4 and third cylinder metal piece 7) after the mask process were obtained.

Further, an ethanol solution containing 10% by mass concentration of iron(II) dodecylbenzenesulfonate was prepared. The above described valve action metals after the mask process were soaked into the solution and taken out, and thereafter were dried at room temperature for 30 minutes in the air. Then the valve action metals were soaked in an aqueous solution containing 50% by mass of ethylene-dioxy thiophene and taken out to be kept in the air for 30 minutes, thereby carrying out polymerization of the aforementioned ethylene-dioxy thiophene. Thereafter, the valve action metals were washed with water and methanol and dried at 80 degrees C. The above described operation was repeated four times so that dielectric film 3 on the inside surface of first cylinder metal piece 4, dielectric film 5 on the outside surface of first cylinder metal piece 4, dielectric film 11 on the inside surface of third cylinder metal piece 12, and dielectric film 13 on the outside surface of first cylinder metal piece 4 were respectively coated with conductive polymer. The conductive polymer was made up of polyethylene-dioxy thiophene for which dodecylbenzenesulfonic acid was used as a dopant. Thus, first cylinder metal piece 4 and third cylinder metal piece 12 including a conductive polymer layer free from defects were obtained. These were soaked in a solvent solution containing carbon graphite and taken out to be dried at room temperature. Further, upon hardening of the surface of carbon graphite, first cylinder metal piece 4 and third cylinder metal piece 12 were soaked in silver paste and taken out to be dried at 60 degrees C. for 15 minutes. Thereafter, these were left standing at room temperature for 3 hours. So far, there were obtained: first cylinder metal piece 4 in which conductive material layers 2, 6 made up of conductive polymer, carbon graphite, and silver paste was formed; and third cylinder metal piece 12 in which conductive material layers 10, 14 made up of the same three materials was formed.

A rectangular metal piece (internal metal piece 1) applied with silver paste was inserted into the inside of first cylinder metal piece 4. Then, silver paste was applied to the outside surface of first cylinder metal piece 4, and this was inserted into the inside of the cylinder of second cylinder metal piece 7. Further, silver paste was applied to the outside surface of second cylinder metal piece 7, and this was inserted into the inside of the cylinder of third cylinder metal piece 12. Furthermore, a thin metal foil (fourth cylinder metal piece 15) was pasted onto the silver paste layer outside third cylinder metal piece 12, and was dried at 60 degrees C. for 30 minutes. Thus, components from internal metal piece 1 to fourth cylinder metal piece 15 were obtained. These were soaked in tetrahydrofuran to dissolve hexafluoropropylene, which is mask resin, thereby removing conductive polymer, carbon graphite and silver paste on the insulating bank, at the same time. Further, dielectric 5 outside both ends of first cylinder metal piece 4 and dielectric film 13 outside both ends of third cylinder metal piece 12 were cut off to obtain multilayer strip line capacitive element 100 of the present example in which the cut part (not shown) was formed.

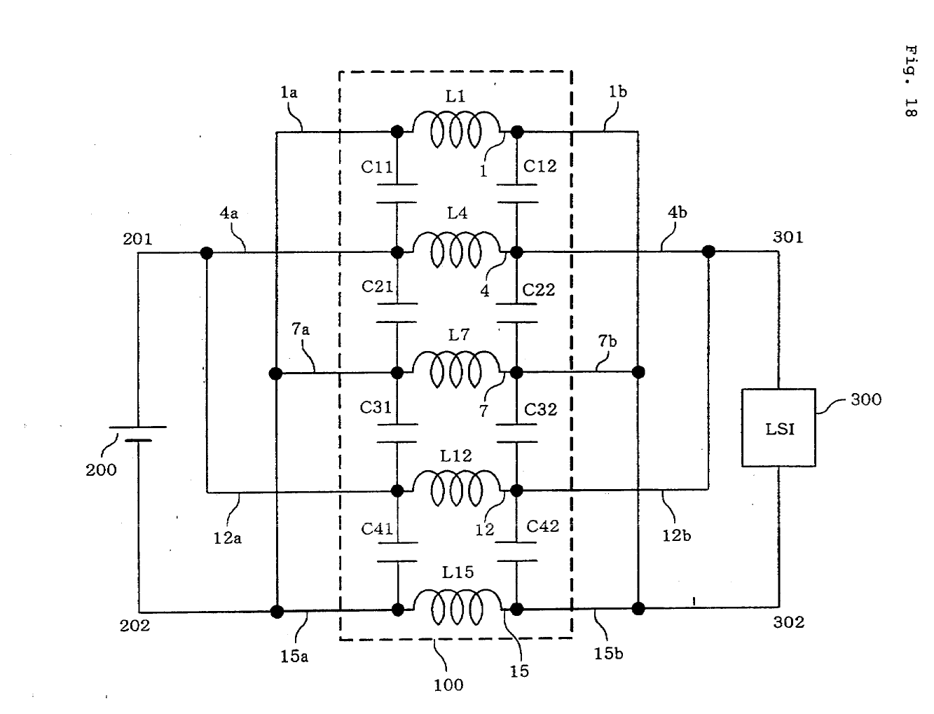

FIG. 18 is an equivalent circuit diagram to show, an example when the present example is used. As shown in the figure, equivalent inductance L1 is parasitic on internal metal piece 1; equivalent inductance L4 on first cylinder metal piece 4; equivalent inductance L7 on second cylinder metal piece 7; equivalent inductance L12 on third cylinder metal piece 12; and equivalent inductance L15 on fourth cylinder metal piece 15. Capacitors C11, C12 are formed between internal metal piece 1 and first cylinder metal piece 4; capacitors C21, C22 between first cylinder metal piece 4 and second cylinder metal piece 7; capacitors C31, C32 between second cylinder metal piece 7 and third cylinder metal piece 12; and capacitors C41, C42 between third cylinder metal piece 12 and fourth cylinder metal piece 15. Here, it is supposed that lead terminals 1a, 1b; 4a, 4b; 7a, 7b; 12a, 12b; 15a, 15b) are placed respectively at both ends of internal metal piece 1, first cylinder metal piece 4, second cylinder metal piece 7, third cylinder metal piece 12, and fourth cylinder metal piece 15. Lead terminals 4a, 12a are commonly connected to positive electrode 201 of power supply 200; and lead terminals 4b, 12b are commonly connected to electrode terminal 301 of LSI 300. Further, lead terminals 1a, 7a, and 15a are commonly connected to negative electrode 202 of power supply 200, and lead terminals 1b, 7b, and 15b are commonly connected to ground terminal 302 of LSI 300. According to the present example, it is possible to utilize a capacity larger than that of Example 1 to thereby achieve a higher noise attenuation effect.

Further, lead terminals 4a and 12a, lead terminals 4b and 12b, and further lead terminals 1a, 7a, and 15a, and lead terminals 1b, 7b, and 15b may be integrated to facilitate the implementation on a printed board.

In the present example, a valve action metal was used for first cylinder metal piece 4 and third cylinder metal piece 12, but on the contrary, a valve action metal may be used for internal metal piece 1, second cylinder metal piece 7, and fourth cylinder metal piece 15. Alternatively, the entire of internal metal piece 1 and first to fourth cylinder metal pieces 4, 7, 12, 15 may be formed of a valve action metal. It is noted that in the present invention, the number of layers of cylindrical metal pieces would not be limited provided that the number is not less than 2. Thus, a valve action metal may be used for metal pieces located at positions of even numbers counted from the inside, or metal pieces located at positions of odd numbers. Alternatively, all the metal pieces may be formed of a valve action metal.

### EXAMPLE 6

Next, although an example in which a lead terminal is formed on the multilayer strip line capacitive element of Example 1 will be described, a lead terminal may be placed as regards the capacitive elements of other Examples in a similar fashion.

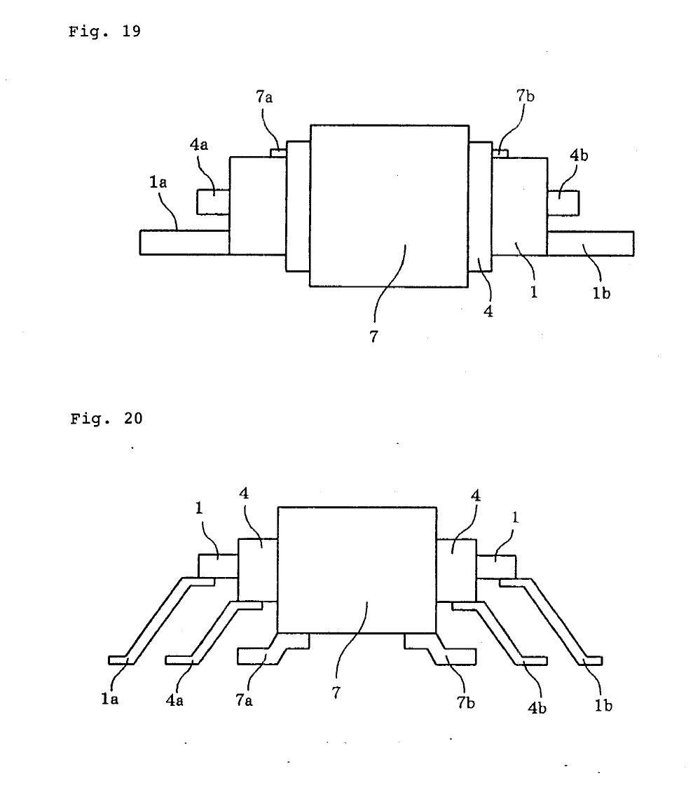

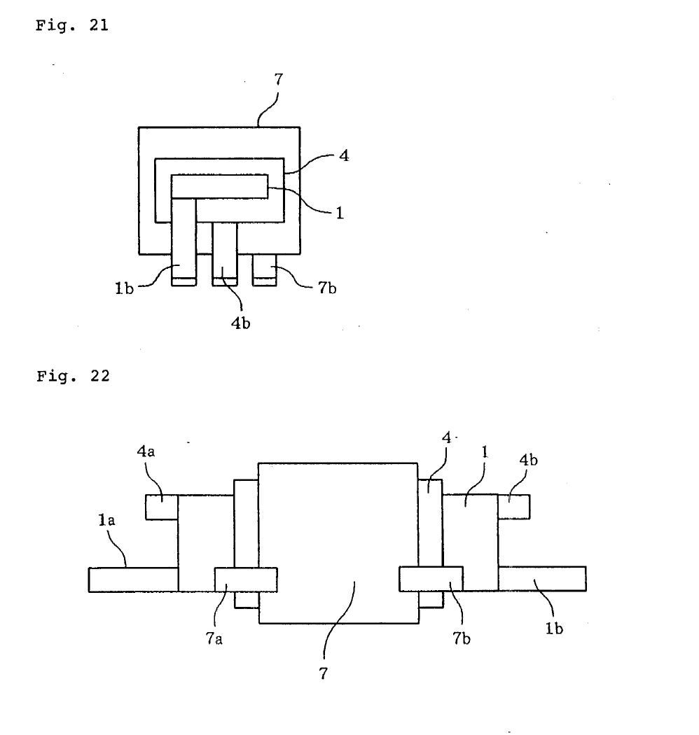

FIGS. 19 to 21 show Example 6 of the present invention, where FIG. 19 is a top view, FIG. 20 is a front view, and FIG. 21 is a side view. Lead terminals 1a, 1b made of metal are electrically connected to both ends of internal metal piece 1; lead terminals 4a, 4b to both ends of first cylinder metal piece 4; and lead terminals 7a, 7b to both ends of second cylinder metal piece 7, of the multilayer strip line capacitive element fabricated in Example 1. It is noted that those lead terminals were bonded to each metal piece with silver paste. Here, for example, lead terminals designated by subscript ‘a’ may be used as an input terminal, and lead terminals designated by subscript ‘b’ may be used as an output terminal. It is also noted that lead terminals 1a, 1b of internal metal piece 1 may be integrally formed with internal metal piece 1. The disposition of six input/output lead terminals 1a, 1b, lead terminals 4a, 4b and lead terminals 7a, 7b is preferably such that input terminals and output terminals are separated at each end of cylinder metals. However, it is needless to say that exact disposition (left-and-right, and fore-and-aft) may be freely designed according to implementation conditions. This will facilitate the implementation on a printed board.

### EXAMPLE 7

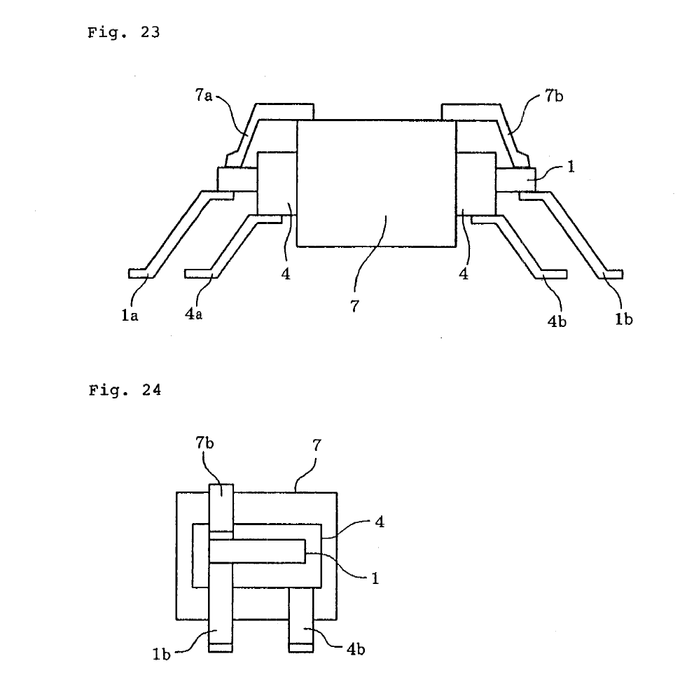

FIGS. 22 to 24 show Example 7 of the present invention, where FIG. 22 is a top view, FIG. 23 is a front view, and FIG. 24 is a side view. In the present example, among lead terminals 1a, 1b, lead terminals 4a, 4b and lead terminals 7a, 7b provided at both ends of internal metal piece 1, first cylinder metal piece 4, and second cylinder metal piece 7, lead terminal la and lead terminal 7a, which are connected to internal metal piece 1 and second cylinder metal piece 7, are integrated, and also lead terminal 1b and lead terminal 7b are integrated. That is, lead terminal 7a is connected to lead terminal 1a or internal metal piece 1 in the vicinity thereof with silver paste, and lead terminal 7b is connected to lead terminal 1b or internal metal piece 1 in the vicinity thereof with silver paste. Further, a metal piece into which lead terminals 1a and 7a or lead terminals 1b and 7b are integrated can be used.

FIG. 25 is an equivalent circuit to show a circuit example that used the present example. As the result of the integration of lead terminals 1a and 7a, and also lead terminals 1b and 7b, capacitors C11 and C21, and also capacitors C12 and C22 are added in parallel. This will decrease the number of pads of a printed board, facilitating implementation on the printed board and the like. This circuit connection shows a case in which the present capacitive element is used as an element having polarity. In FIG. 25, lead terminal 4a of first cylinder metal piece 4 is connected to the wiring to positive electrode 201 of power supply 200, and lead terminal la of internal metal piece 1 and lead terminal 7a of second cylinder metal piece 7 are connected to the wiring for negative electrode 202 of power supply 200. Lead terminal 4b is connected to the wiring for power supply terminal 301 of LSI 300, and lead terminal 1b and lead terminal 7b are connected to ground terminal 302 of LSI 300. In this circuit, high frequency noise that is generated by power supply 301 of LSI 300 is filtered by using a filter that is made up of an equivalent capacity composed of capacitors C11, C21 and capacitors C12, C22 and an equivalent inductance composed of inductances L4, L1 and L7. Therefore, the afore mentioned noise will little be transferred to power supply 200 side.

### EXAMPLE 8

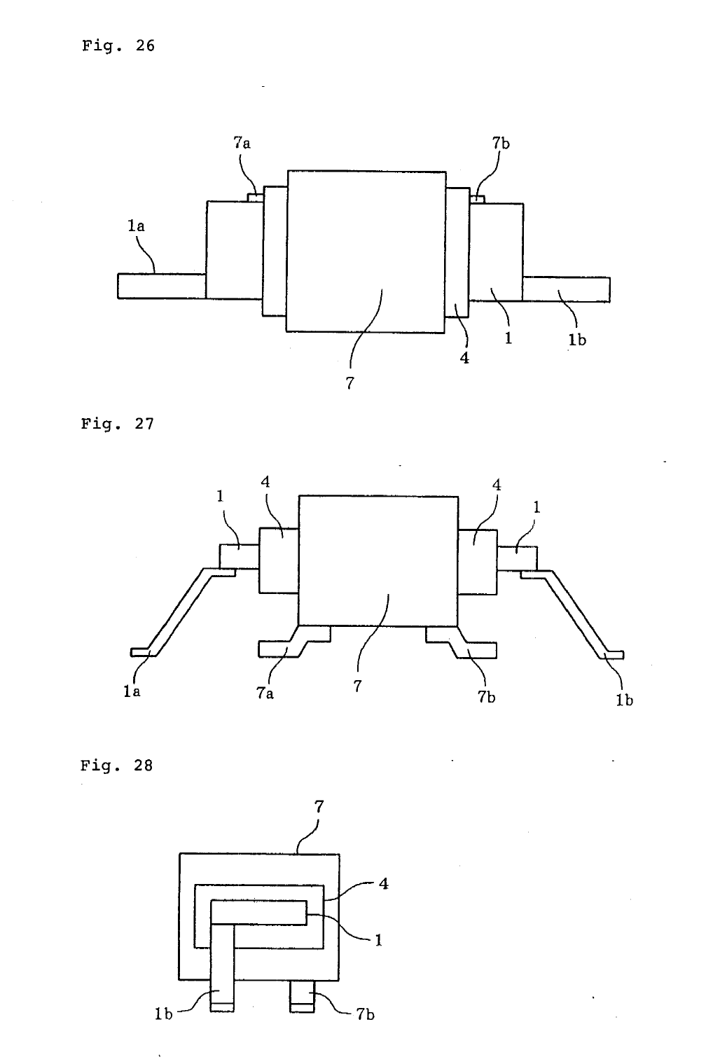

FIGS. 26 to 28 show Example 8 of the present invention, where FIG. 26 is a top view, FIG. 27 is a front view, and FIG. 28 is a side view. In the present example, no lead terminal is provided on first cylinder metal piece 4, and lead terminals 1a, 1b and lead terminals 7a, 7b are provided only on both ends of internal metal piece 1 and second cylinder metal piece 7.

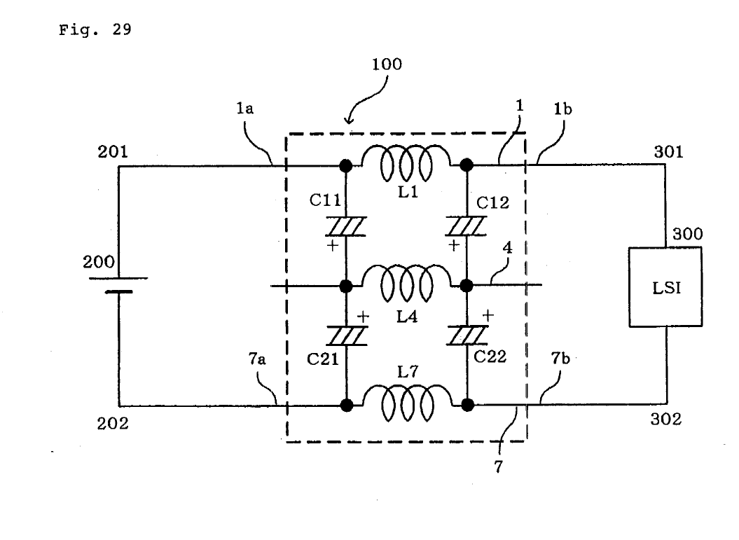

FIG. 29 is an equivalent circuit diagram to show an example when Example 8 is used. The circuit shown in FIG. 29 is an example in which a multilayer strip line capacitive element is used as a non-polarity element. In the figure, both ends of first cylinder metal piece 4 are kept open, lead terminal 1a is connected to the wiring for positive electrode 201 of power supply 200, and lead terminal 7a is connected to the wiring for negative electrode 202 of power supply 200. Further, lead terminal 1b is connected to the wiring for power supply terminal 301 of LSI 300, and lead terminal 7b is connected to ground terminal 302 of LSI 300. As the result of such connection, capacitors C11, c12 and capacitors C21, C22, each having a polarity, are connected at respective positive electrodes (first cylinder metal piece 4). In this case, when a voltage is applied between internal metal piece 1 and second cylinder metal piece 7, either one of capacitor C11 (C12) or capacitor C21 (C22) is subjected to a forward voltage and the other to a reverse voltage. In the wiring connection of FIG. 29, although capacitors C11, C12 are reversely connected to be short-circuited, capacitors C21, C22 are forwardly connected. Therefore, only capacitors C21, C22 will function. Further, since the number of lead terminals can be reduced, it is possible to reduce the number of pads of a printed board thereby facilitating implementation on a printed board and the like. In this circuit, noise which is generated by the wiring of power supply 301 of LSI 300 will be filtered by using a filter that is made up of capacitors C21, C22 and equivalent inductance composed of inductances L1, L4, L7, and will little be transferred to power supply 200 side.

According to the present example, it is possible to realize a function of non-polarity, with which a multilayer strip line capacitive element has no directionality of connection and therefore can be applied even to a negative polarity power supply to which it has not been applicable. Further, since there is no need to consider the disposing direction of the element, it is also possible to achieve the effect of improving ease of implementation.

### INDUSTRIAL APPLICABILITY

Utilization examples of the capacitive element of the present invention include the application to power delivery wiring. For example, the inventive capacitive element may be used for power supply decoupling to suppress high-frequency electromagnetic waves (current and voltage) which are generated at a digital electronic circuit or at an analog electronic circuit and which spread over power delivery wiring. Moreover, types of usage that exploit non-polarity electric characteristics includes use examples described below in addition to the use for power supply wiring.

The inventive capacitive element may also be used for a high-frequency cut-off filter and a smoothing circuit which are inserted into a signal line through which a low voltage alternate signal passes, among the sensor outputs after a voltage divider/current shunt circuit for monitoring a direct current power supply of which voltage application direction is unknown, and the voltage, frequency, and current of a commercial power supply.

Alternatively, the inventive capacitive element can also be used for a high-frequency cut-off filter to be inserted into a two-source operational amplifier output. It can also be used for a high-frequency cut-off filter to be used in differential signal circuits.

1-12. (canceled)

13. A multilayer strip line capacitive element, comprising:
a strip-shaped metal piece;
a plurality of cylindrical metal pieces having different sizes and being disposed in multiple layers surrounding said strip-shaped metal piece;
a dielectric film and a conductive material layer which are located between a cylindrical metal piece innermostly located among said plurality of cylindrical metal pieces and said strip-shaped metal piece, and between adjoining said cylindrical metal pieces, and which are laminated and disposed at positions symmetric with respect to a side wall of each of said cylindrical metal pieces.

14. The multilayer strip line capacitive element according to claim 13, wherein
supposing that said strip-shaped metal piece and said plurality of cylindrical metal pieces be called a first, second, . . . , and n-th (where n is an integer not less than 3) metal piece in that order from the inside,
a plurality of (n-1)-th metal pieces in conjunction with a metal piece located thereinside are disposed in an array within the n-th metal piece.

15. The multilayer strip line capacitive element according to claim 13, wherein
supposing that said strip-shaped metal piece and said plurality of cylindrical metal pieces be called a first, second, . . . , and n-th (where n is an integer not less than 3) metal piece in that order from the inside,
said metal pieces are laminated and disposed in the order of said dielectric film and said conductive material layer, or in the order of said conductive material layer and said dielectric film, or in the order of said dielectric film, said conductive material layer and said dielectric film, from m-th (where, m is an integer not less than 2 and not more than n-1) metal piece.

16. The multilayer strip line capacitive element according to claim 13, wherein
supposing that said strip-shaped metal piece and said plurality of cylindrical metal pieces be called a first, second, . . . , and n-th (where n is an integer not less than 3) metal piece in that order from the inside,
only all odd-numbered metal pieces, only all even-numbered metal pieces, or all the metal pieces are formed of a metal having a valve action.

17. The multilayer strip line capacitive element according to claim 16, wherein said metal having a valve action is aluminum, tantalum, niobium, or titanium.

18. The multilayer strip line capacitive element according to claim 13, wherein said dielectric film is a metal oxide film.

19. The multilayer strip line capacitive element according to claim 13, wherein said conductive material layer includes a conductive polymer layer.

20. The multilayer strip line capacitive element according to claim 19, wherein said conductive polymer layer is formed of one or more compounds selected from a group consisting of polypyrroles, polythiophenes and polyanilines, and derivatives thereof.

21. The multilayer strip line capacitive element according to claim 13, wherein said conductive material layer includes a conductive polymer layer, a carbon graphite layer, and a silver paste layer, and wherein said conductive polymer layer, said carbon graphite layer, and said silver paste layer are laminated in that order from a metal piece, on the surface of which said dielectric film is formed, toward a metal piece adjoining thereto.

22. The multilayer strip line capacitive element according to claim 21, wherein said conductive polymer layer is formed of one or more compounds selected from a group consisting of polypyrroles, polythiophenes and polyanilines, and derivatives thereof.

23. The multilayer strip line capacitive element according to claim 13, wherein a lead terminal is formed on each end of respective said strip-shaped metal piece and said plurality of cylindrical metal pieces.

24. The multilayer strip line capacitive element according to claim 23, wherein lead terminals, which are formed on any two or more metal pieces among said strip-shaped metal piece and said plurality of cylindrical metal pieces, are integrated.

25. The multilayer strip line capacitive element according to claim 13, wherein the number of layers of said plurality of cylindrical metal pieces is two, and wherein a lead terminal is formed only on each end of an outermostly located cylindrical metal piece and on each end of said strip-shaped metal piece.
